(19) United States
(12) Patent Application Publication
(10) Pub. No.: US 2010/0055992 A1
(43) Pub. Date: Mar. 4, 2010

(54) TERMINAL DEVICE, CONNECTOR AND ADAPTOR

(76) Inventors: Deng Liu, Shanghai (CN); Qilin Chen, Shanghai (CN)

Correspondence Address: 3M INNOVATIVE PROPERTIES COMPANY, PO BOX 33427, ST. PAUL, MN, 55133-3427, US

(21) Appl. No.: 12/531,712

(22) PCT Filed: Mar. 5, 2008
(86) PCT No.: PCT/US08/55939

§ 371 Date: Sep. 17, 2009

(30) Foreign Application Priority Data
Mar. 30, 2007 (CN) 200710091451.0

(51) Int. Cl. H01R 13/40; H01R 43/16

(52) U.S. Cl. 439/733.1; 29/874

(57) ABSTRACT

The present invention relates to a terminal device comprising an insulator including a solder slot formed in a surface thereof; and a contact including a body portion, and a solder terminal portion formed at an end of the body portion and including a width that is larger than a thickness thereof, wherein the solder terminal portion is vertically disposed in the solder slot so that a width direction of the solder terminal portion is substantially identical with a depth direction of the solder slot. At least one embodiment of the present invention at least solves partially and efficiently the problems occurring during soldering the contact of a fine pitch connector to a cable, and is simple in structure and low in manufacturing cost.

### FIELD

The present invention relates to a terminal device, more particularly, to a solder type terminal device adapted for a fine pitch connector and having an excellent processing property of soldering and a high reliability. The present invention also relates to a connector including the above-mentioned solder type terminal device, and to an adaptor including the above-mentioned connector.

### BACKGROUND

Solder type cable connectors are widely used in the global market. The developments of miniaturization and high density are necessary to achieve fine pitch connectors to be soldered with the cable, in which the cable comprises a plurality of wires, and the connector comprises a corresponding terminal device. The terminal device comprises a plurality of contacts spaced apart at small pitches. During assembling, each wire is soldered to a solder terminal portion of the corresponding contact, thus achieving electrical connection.

Conventionally, when soldering the fine pitch connector with the cable, respective wires of the cable are placed horizontally on the solder terminal portions of the contacts, respectively, from above, thus resulting in the following problems: firstly, since the pitch between adjacent soldering units is small, the effective contact area between the solder terminal portion of the contact and the corresponding wire decreases, thereby the processing property of soldering becomes poor and the soldering reliability is reduced; secondly, since the pitch between adjacent soldering units is small, the spacing between adjacent soldering units is decreased, so that shorting tends to occur between adjacent soldering positions, thus making the soldering process difficult and reducing the soldering reliability.

To satisfy requirements of some electrical specification and performance in certain cases, it is required to solder big gauge wires to the contacts of the fine pitch connector, in which case the aforesaid problems will become more serious.

### SUMMARY

At least one embodiment of the present invention is directed to solve at least one aspect of the aforesaid problems existing in the prior art.

A first embodiment of the present invention is to provide a terminal device, comprising an insulator including a solder slot formed in a surface thereof; and a contact including a body portion, and a solder terminal portion formed at an end of the body portion and including a width that is larger than a thickness thereof, wherein the solder terminal portion is vertically disposed in the solder slot so that a width direction of the solder terminal portion is substantially identical with a depth direction of the solder slot.

In the first embodiment, the terminal device solves at least one aspect of the problems occurring during soldering wires of a cable to contacts of a fine pitch connector. Additionally, the terminal device is simple in structure and low in cost.

A second embodiment of the present invention is to provide a method of manufacturing a terminal device, comprising: preparing an insulator including a solder slot formed in a surface thereof; preparing a contact including a body portion, and a solder terminal portion formed at an end of the body portion and including a width that is larger than a thickness thereof; and disposing the solder terminal portion vertically in the solder slot so that a width direction of the solder terminal portion is substantially identical with a depth direction of the solder slot.

In the second embodiment, the method of manufacturing a terminal device solves at least one aspect of the problems occurring during soldering wires of a cable to contacts of a fine pitch connector. Additionally, the method is simple in process and low in cost.

A third embodiment of the present invention is to provide a connector comprising a terminal device according to the first embodiment of the present invention.

With the connector in the third embodiment, the soldering process can be performed quickly, and the soldering reliability and stability of manufacturing process are high even if the connector is soldered with big gauge wires. At the same time, an excellent electrical performance can be achieved and the cost is low.

A fourth embodiment of the present invention is to provide an adaptor including the connector according to the third embodiment of the present invention.

### BRIEF DESCRIPTION OF THE DRAWINGS

FIG. 1 is a perspective view of a contact of the terminal device according to an embodiment of the present invention;

FIG. 2 is a cross-sectional view of the terminal device according to the embodiment of the present invention, with the solder terminal portions of the contacts being vertically disposed in the solder slots of the insulator respectively;

FIG. 3 is a cross-sectional view of the terminal device according to the embodiment of the present invention, with each wire being disposed in the solder slot at a side of the solder terminal portion;

FIG. 4 is a schematic view showing a terminal device after the wires are soldered with the solder terminal portion, respectively, by using a solder material;

FIG. 4a is a close-up view of a portion of the terminal device of FIG. 4;

FIG. 5 is an exploded perspective view of the connector according to an embodiment of the present invention;

FIG. 6 is an exploded perspective view of the terminal device according to the embodiment of the present invention in a state before the contacts are assembled with the insulator;

FIG. 7 is an exploded perspective view of the terminal device according to the embodiment of the present invention in a state after the contacts are assembled with the insulator;

FIGS. 8 and 8a respectively show a perspective view and a cross-sectional view of a further insulator of the connector;

FIGS. 9 and 9a respectively shows a perspective view and a cross-sectional view of the terminal device of FIG. 6;

FIG. 10 is a partial sectional view of the connector according to the embodiment of the present invention;

FIG. 11 is view showing a state before the a further insulator of the connector is assembled with a shroud;

FIG. 12 is an exploded perspective view of the adaptor according to the embodiment of the present invention; and

FIG. 13 is a perspective view of the adaptor according to the embodiment of the present invention in an assembled state.

### DETAILED DESCRIPTION

Embodiments of the present invention will be described in detail with reference to the accompanying drawings, embodiments described herein are explanatory and illustrative and shall not be construed to limit the present invention. The same elements are denoted by like reference numerals throughout the descriptions.

As shown in FIGS. 2-3 and 6-7, the terminal device 100 according to an embodiment of the present invention comprises an insulator 2 including a substantially rectangular parallelepiped shape, and a plurality of contacts 1.

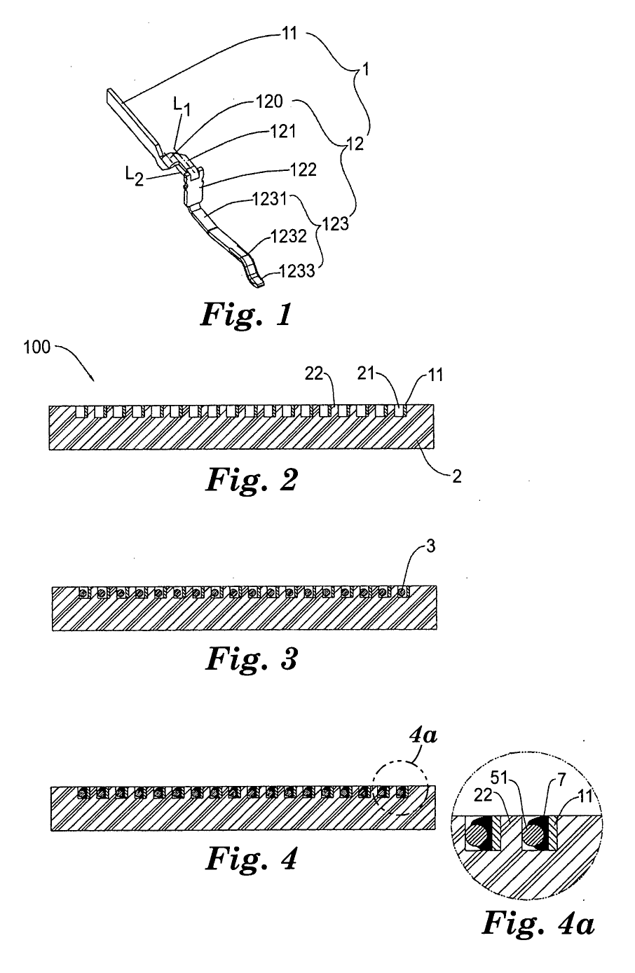

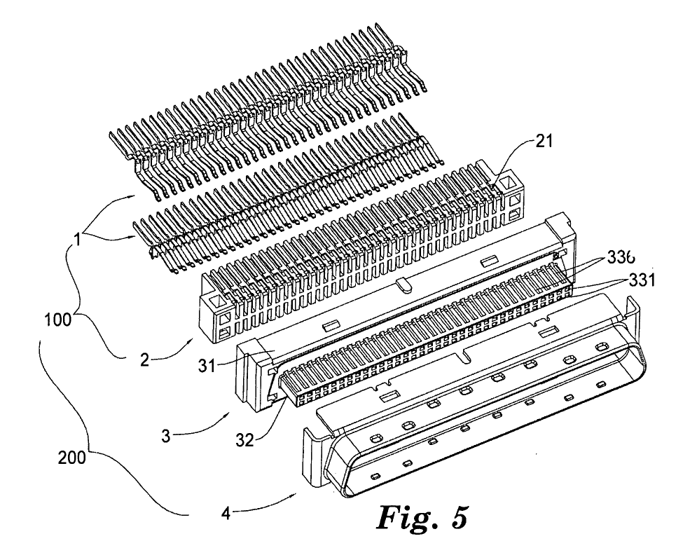

As shown in FIG. 1, each contact 1 comprises a body portion 12, and a solder terminal portion 11 formed at an end of the body portion 12, in which the solder terminal portion 11 comprises a thickness, a width that is larger than the thickness, and a predetermined length. More particularly, as shown in FIGS. 1 and 5, the body portion 12 comprises a twisted portion 120, a transition portion 121, a hold portion 122, and a contact portion 123.

In this embodiment, the solder terminal portion 11 is flat, for example, the solder terminal portion 11 may be in the form of a sheet.

In this embodiment, a plurality of solder slots 21 are formed side by side in the top surface (the upper surface in FIGS. 1-3) of the insulator 2, are spaced at equal intervals apart, and penetrate through the top surface of the insulator 2. In other words, the longitudinal direction of the solder slots 21 is identical with the width direction of the insulator 2 (as shown in FIG. 4a). Adjacent solder slots 21 are spaced by separating ribs 22. In the embodiment shown in FIGS. 2 to 4, the solder slots 21 have the same width and depth.

As shown in FIGS. 2 to 4, a plurality of contacts 1 are disposed in the slots 21, respectively, so that the width direction of the solder terminal portion 11 is identical with the depth direction of the solder slot 21.

In the embodiment shown in FIGS. 3 and 4, the solder terminal portion 11 is disposed in the solder slot 21 so as to abut against a side wall of the solder slot 21. Therefore, when a wire 51 of a cable 5 is soldered to the solder terminal portion 11, a front end 511 of the wire 51 will be disposed in the solder slot 21 at a side of the solder slot 21. Consequently, this is advantageous to allow the solder material 7 to contact with the solder terminal portion 11 and the wire 51 so as to benefit soldering of the solder terminal portion 11 and the wire 51. At the same time, by disposing the solder terminal portion 11 vertically in the solder slot 21, the restriction due to the small pitch between the soldering units can be eliminated to some extent, and the effective soldering area of the solder terminal portion 11 can be obtained. Moreover, the separating ribs 22 between adjacent solder slots 21 can efficiently prevent shorts from occurring between the soldering units.

Here, the term “soldering unit” means a unit formed by soldering the wire 51 to the solder terminal portion 11 in the solder slot 21 with the soldering material 7.

In the above embodiment, the insulator 2 comprises a substantially rectangular parallelepiped shape, but the present invention is not limited to this. For example, the insulator 2 can have a circular cross-section, and the solder slots 21 can be formed in the circumferential surface of the insulator 2.

In the above embodiment, a plurality of solder slots 21 are formed and spaced at equal intervals apart in the top surface of the insulator 2, and the solder slots 21 have the same depth and width. But the present invention is not limited to this. For example, based on the gauge of the wire 51 to be soldered, the solder slots 21 can have different depths and widths. Moreover, according to the number of the wires 51 to be soldered, the solder slot 21 can be of any suitable number. For example, in the case of one wire 51, only one solder slot 21 needs to be formed. In addition, the solder plurality of slots 21 can be spaced at unequal intervals apart.

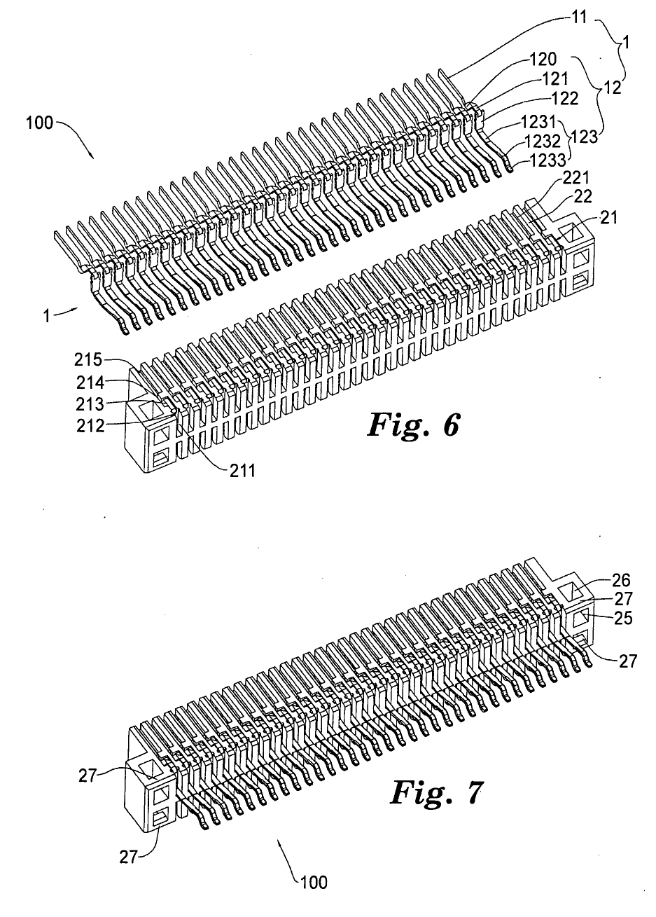

In the above embodiment, the solder slots 21 are formed in the top surface of the rectangular parallelepiped insulator 2. In another embodiment, the solder slots 21 can be formed simultaneously in the top and bottom surface of the insulator 2, as shown in FIGS. 6 and 7. Further, the solder slots 21 formed in the top surface can be symmetrical with those formed in the bottom surface.

In FIGS. 2 to 4, the solder slots 21 comprise a rectangular cross section, but the cross section of the solder slots 21 can be any suitable shapes such as U-shape and square shape. In an embodiment of the present invention, the bottom surface of the solder slots 21 can be formed as a flat surface or a bevel inclined downward. Alternatively, the bottom surface of the solder slots 21 can comprise a chamfer, so that the shape of the bottom surface of the solder slots 21 is adapted to the shape of the contact 1.

The cable connector 200 according to the embodiment of the present invention will be described below.

As shown in FIG. 5, the connector 200 according to an embodiment of the present invention comprises the terminal device 100, a further insulator 3, and a metal shielding shroud 4.

In FIG. 5, two rows of the contacts 1 of the terminal device 100 are separated from the insulator 2 including a plurality of solder slots 21 in the top and bottom surfaces, that is, the solder terminal portions 11 of the contacts 1 are not disposed in the solder slots 21.

Referring to FIGS. 1 and 6, the construction and formation process of the contact 1 will be described below.

In an embodiment of the present invention, each contact 1 comprises a flat one-piece sheet member (for example a copper sheet), in which the solder terminal portion 11 is formed at one end of the body portion 12. At the initial state, the solder terminal portion 11 and the body portion 12 are positioned in the same plane. That is, the width direction of the solder terminal portion 11 is consistent with that of the body portion 12. Referring to FIG. 1, the body portion 12 has a longitudinal central axis L1 extending along the longitudinal direction thereof, and the solder terminal portion 11 has longitudinal central axis L2 extending along the longitudinal direction thereof. The longitudinal central axis L1 and the longitudinal central axis L2 are substantially parallel with each other and spaced apart from each other by a predetermined distance in a width direction of the contact 1. During the formation of solder terminal portion 11, the solder terminal portion 11 is bent or twisted by about 90 degrees about a predetermined axis parallel with the longitudinal axis thereof so that the solder terminal portion 11 is positioned in a vertical state with respect to the body portion 12. As a result, the width directions of the solder terminal portion 11 and the body portion 12 are orthogonal to each other.

As shown in FIGS. 1 and 6, a groove is formed in the solder terminal portion 11. Consequently, during the twisting or bending of the solder terminal portion 11, the twisting force is effectively reduced, and occurrence of a crack or breakage during the twisting or bending of the solder terminal portion 11 is effectively prevented. During the twisting or bending process, a portion of the body portion 12 which is connected with the solder terminal portion 11 deforms so as to form a twisted portion or bent portion 120. In one embodiment, the twisted portion or bent portion 120 is tangential to the plane of the solder terminal portion 11 and that of the body portion 12.

It should be noted that, at the initial state, the longitudinal central axis of terminal portion 11 can also be consistent with that of the body portion 12. In other words, the solder terminal portion 11 and the body portion 12 have the same longitudinal central axis. By twisting by 90 degrees an end (i.e. tail end) of the contact 11 about the longitudinal axis of the contact 11 so that the solder terminal portion 11 is in a vertical direction relative to the body portion 12, and joined to a twisted portion 120 of the body portion 12, as shown in FIGS. 1 and 6.

In the embodiment shown in FIGS. 1 and 5, each contact 1 has a substantial Z-shape.

As stated above, the body portion 12 comprises a twisted portion 120, a transition portion 121, a hold portion 122, and a contact portion 123. The twisted portion 120 is joined to the solder terminal portion 11. The hold portion 122 is formed by a vertical portion located at a substantial center of the contact 1, and is to be mounted to the insulator 2 so as to mount the contact 1 to the insulator 2.

The transition portion 121 is located between the twisted portion 120 and an upper end of the hold portion 122, so that the solder terminal portion 11 is twisted by 90 degrees with respect to the transition portion 121, that is, the width direction of the transition portion 121 is substantially orthogonal to that of the solder terminal portion 11. The twisted portion 120 connects the solder terminal portion 11 and the transition portion 121. In one embodiment, as shown in FIGS. 1 and 6, the transition portion connecting the twisted portion 120 and the transition portion 121 is chamfered so as to avoid occurrence of interference when a plurality of contacts are disposed adjacent to each other.

The contact portion 123 is formed by a horizontal portion of the contact 1 which is joined to a lower end of the hold portion 122. Particularly, the contact portion 123 comprises an elastic support part 1231, a lapping contact part 1233, and a projection contact part 1232.

The elastic support part 1231 is formed by a horizontal portion of the contact portion 123 which is joined to the lower end of the hold portion 122.

The lapping contact part 1233 is formed at a free end of the contact portion 123 away from the hold portion 122, that is, the lapping contact part 1233 is formed by a short portion at a free end of the contact portion 123. When the terminal device 100 is used to form a connector 200, the lapping contact part 1233 is to contact a further insulator 3 of the connector 200, and be positioned relative to the further insulator 3 (described later).

The projection contact part 1232 is located between the elastic support part 1231 and the lapping contact part 1233 and protrudes upward (as best seen in FIG. 10), and the projection contact part 1232 is to be connected to another connector, thus achieving electrical connection. When viewed from a side of the contact 1, the projection contact part 1232 has a substantially arc shape, as shown in FIGS. 9 and 10.

A method of manufacturing the terminal device 100 according to an embodiment of the present invention will be described below.

According to the embodiment of the present invention, as shown in FIG. 2, firstly, a substantially rectangular parallelepiped insulator 2 is prepared, in which a plurality of solder slots 21 are formed in the top surface of the insulator 2.

Next, a plurality of contacts 1 each having a body portion 12 and a solder terminal portion 11 are prepared, in which the solder terminal portion 11 is flat and includes a thickness, a width greater than the thickness, and a predetermined length.

Finally, the solder terminal portions 11 of each contact 1 are disposed vertically in the corresponding solder slot 21, so that the solder terminal portion 11 abuts against the side wall of the corresponding solder slot 21, thereby the width direction of each solder terminal portion 11 is identical with the depth direction of the corresponding solder slot 21. Therefore, the terminal device 100 according to the embodiment of the present invention is achieved, as shown in FIG. 4.

According to an embodiment of the present invention, the solder terminal portion 11 is disposed in the solder slot 21 so as to abut a side wall of the solder slot 21. In at least one embodiment, the solder slots 21 are formed side by side and spaced at equal intervals apart, and have the same depth and width.

According to a further embodiment of the present invention, a plurality of solder slots 21 are also formed in the bottom surface of the insulator 2, and the solder slots 21 formed in the bottom surface are spaced at equal intervals apart and have the same depth and width, so that two rows of the contacts 1 are disposed in the solder slots 21 formed in the top and bottom surface respectively, as shown in FIG. 5.

As described above, in this embodiment, the solder slots 21 comprise a substantially rectangular cross section. But the present invention is not limited to this.

More particularly, each contact 1 is formed by a flat one-piece member such as a copper sheet, and the solder terminal portion 11 is formed by twisting an end of the contact 1 about the longitudinal axis thereof by 90 degrees, and a portion of the body portion 12 joined to the solder terminal portion 11 is formed as a twisted portion 120. The contact 1 is bent twice at a substantial center portion thereof, so that the contact 1 has a substantial Z shape. According to this embodiment, the contact 1 can be manufactured more simply and at a low cost.

Further, a middle part of the horizontal contact portion 123 of the Z-shaped contact 1 is protruded upward so as to form the projection contact part 1232, the projection contact part 1232 is used to be connected to another connector. The vertical portion of the Z-shaped contact 1 is formed as the hold portion 122, and the hold portion 122 is used to be fixed to the insulator 2, thus fixing the contact 1 to the insulator 2, as shown in FIGS. 6 and 7. The transition portion 121 is between the hold portion 122 and the twisted portion 120. The lapping contact part 1233 is located at a free end of the contact portion 123 for contacting with the further insulator 3 of the connector 200, and is positioned against the beam portion 332 of further insulator 3.

According to the foresaid embodiments of the present invention, the terminal device is simple in structure and low in manufacturing cost, and the problems occurring conventionally during soldering the fine pitch connector to the cable can be solved to some extent. In addition, the terminal device of the present invention is advantageous in improving the processing property of soldering, increasing the stability of the manufacturing process and soldering reliability. In the case of a big gauge wire, the above advantages and features will be more apparent.

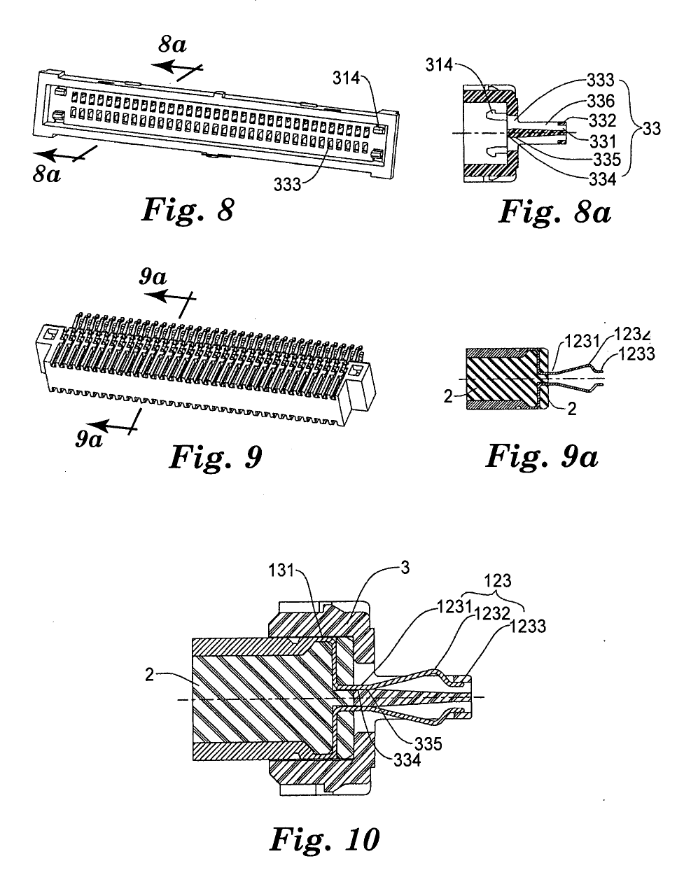

FIG. 8 shows a perspective view and FIG. 8a shows a cross-sectional view of a further insulator of the connector and FIG. 9 shows a perspective view and FIG. 9a shows a cross-sectional view of the terminal device of FIG. 7. For purpose of brevity, only one row of contacts are disposed on the insulator 2 in FIG. 7.

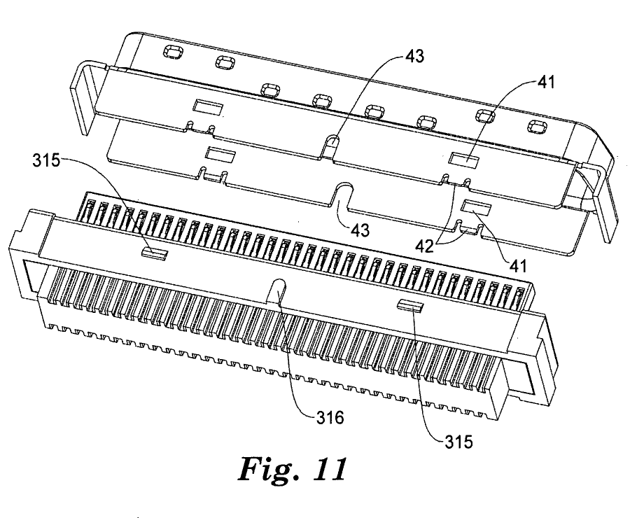

As shown in FIGS. 9 and 10, when two rows of contacts 1 are assembled to the insulator 2 so as to form the terminal device 100, the terminal device 100 can be assembled to the further insulator 3, and then assembled to the shroud 4, thereby the connector 200 is achieved, as shown in FIG. 11.

As shown in FIG. 10, after the terminal device 100 is assembled to the further insulator 3, the insulator 2 and the contacts 1 are partly received in a cavity formed at a rear portion of the further insulator 3.

In this embodiment, the insulator 2 comprises a substantially rectangular parallelepiped shape, and a plurality of solder slots 21 are formed in the top and bottom surfaces of the insulator 2 respectively, and spaced at equal intervals apart. The solder slots 21 have the same width and depth, and a substantial rectangular cross section. The contacts 1 in the form of two rows are disposed in the solder slots 21 formed in the top and bottom surfaces of the insulator 2 respectively.

As shown in FIGS. 5, 6 and 7, structures formed at the both ends of the insulator 2 are used to mount the insulator 2 to the further insulator 3, which will be described in detail later.

Referring to FIGS. 8, 10 and 12, the further insulator 3 comprises a body 31, and a tongue part 32 extended forward from the body 31. The cavity is formed at the rear portion of the body 31. A plurality of channels 33 are formed in the top and bottom surfaces of the tongue part 32, so that the channels 33 penetrate through the tongue part 32 in a longitudinal direction of the tongue part 32, and through a portion of the body 31 in the longitudinal direction so as to communicate with the cavity. The channels 33 correspond to the contacts 1 mounted to the insulator 2, respectively.

Each channel 33 is formed at its front end portion with a front square hole portion 331. The front square hole portion 331 is extended in the longitudinal direction of the tongue part 32 and through the front end surface of the tongue part 32, at the same time, the channels 33 formed at the top surface of the tongue part 32 are partially opened upward and the channels 33 formed at the bottom surface of the tongue part 32 are partially opened downward respectively, so that a beam portion 332 is formed at the front end of each channel 33.

Each channel 33 is formed at its rear end portion with a rear square hole portion 333 having a relatively large size. The rear square hole portion 333 is extended through a portion of the body portion 31 so as to communicate with the cavity, and the guide angle 334 formed at the bottom of the rear square hole portion 333 is used to guide the passage of the contact 1. The planar surface 335 formed at the bottom of the rear square hole portion 333 corresponds to the bottom of the elastic support part 1231 of the contact 1 assembled to the insulator 2 in level. After the terminal device 100 is assembled to the further insulator 3, the planar surface 335 formed at the bottom of the rear square hole portion 333 supports the bottom of the elastic support part 1231 of the contact 1, as shown in FIG. 10, so that consistency of the geometric shape of the contact portions 123 of the contacts 1 can be increased and the mechanical features of the contacts 1 can be improved.

A groove portion 336 is formed at a middle part of each channel 33. The bottom of the groove portion 336 is joined to the bottoms of the front and rear square hole portions 331, 333 via a bevel. During assembling, the contact portion 123 of the contact 1 enter into the corresponding channel 33, and the lapping contact part 1233 is inserted into the front square hole portion 331 so as to be lapping-joined to the beam portion 332.

As shown in FIG. 7, two engaging square holes 25 and 26 perpendicular to each other are formed at end sides of the insulator 2. The engaging square holes 25 and 26 are in communication with each other, so that four horizontal beams 27 are formed by the four engaging square holes 25 and 26. Correspondingly, four catch detents 314 are formed inside the cavity of the further insulator 3. During assembling, the catch detents 314 are inserted into the engaging square holes 25 respectively. When the front portion of the insulator 2 touches the bottom of the cavity of the further insulator 3, the catch detents 314 are engaged with the horizontal beams 27, so that the insulator 2 and the further insulator 3 are fixed together.

Referring to FIG. 11, two square holes 41 are formed in the upper wall and the lower wall of the shroud 4, but the present invention is not limited to this, the square holes 4 can be of any suitable number.

When the shroud 4 is assembled to the further insulator 3, the guide portions 42 of the shroud 4 guide the engagement between the square holes 41 and the wedged bosses 315 formed on the body 31 of the further insulator 3. At the same time, two notches 43 are formed in the edges of the upper wall and the lower wall of the shroud 4 respectively so as to engage with the two bumps 316 formed on the body 31 of the further insulator 3, and the two notches 43 formed in the same edge have different sizes, so that the shroud 4 and the further insulator 3 are positioned with respect to each other and wrong assembling of the shroud 4 can be prevented.

As shown in FIG. 11, the connector 200 according to the embodiment of the present invention is a plug connector. However, a person skilled in the art can understand that the connector 200 can also be a receptacle connector.

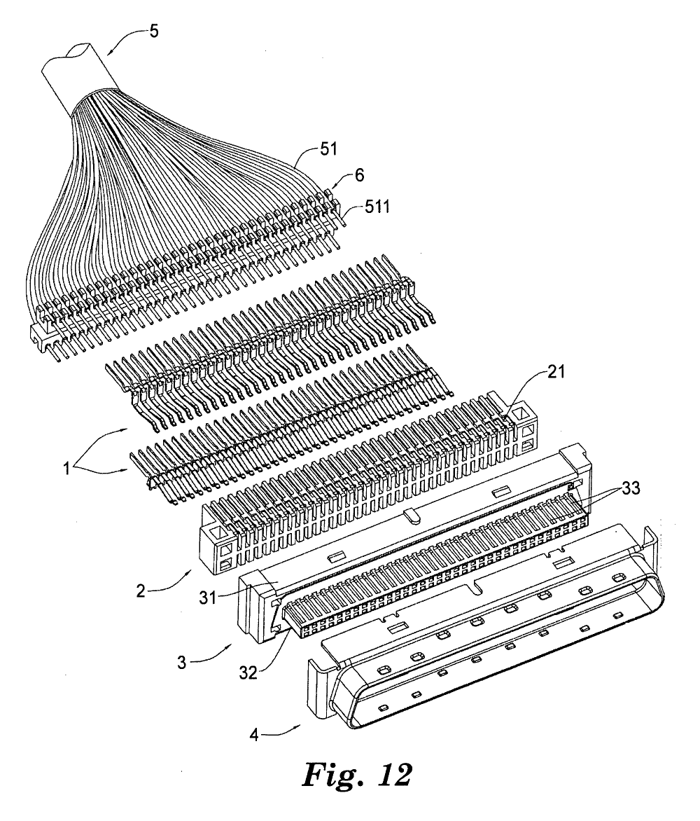

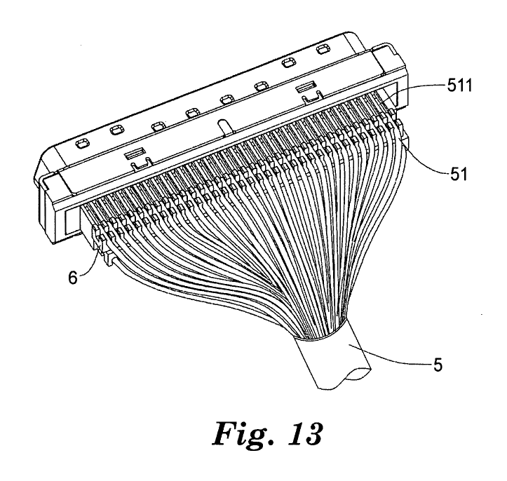

FIG. 12 is an exploded perspective view of the adaptor according to the embodiment of the present invention, and FIG. 13 is a perspective view of the adaptor according to an embodiment of the present invention in an assembled state.

The adaptor according to an embodiment of the present formed by the connector 200 and the cable 5 will be described below.

It should be noted that so-called “adaptor” in the present invention means an apparatus formed by soldering the cable 5 to the connector 200.

As shown in FIG. 12, the adaptor according to the embodiment of the present comprises the connector 200, the cable 5 having a plurality of wires 51, and a wire-separating block 6.

The wire-separating block 6 is formed with a plurality of passages spaced apart from one another, and the plurality of wires 51 are extended through the passages so as to be soldered to a side the solder terminal portions 11 of the contacts 1 respectively. In FIG. 12, the position where the wires pass through wire-separating block 6 is the position where the passage is formed.

In an embodiment of the present invention, since the wires 51 may have different gauges, the passages may have different cross-sectional areas. Accordingly, the solder slots 21 may have different cross-sectional areas so as to be adapted for the wires 51 of different gauges. For example, when two wires of the wires 51 have a larger diameter than the remaining wires, two passages of the passages shall have a larger width than the remaining passages and two solder slots of the solder slots 21 shall have a larger width than the remaining passages so as to conform with the two wires having larger diameter.

Alternatively, the passages can be formed as slots similar to the solder slots 21, and the passages can have different cross-sectional areas.

Referring to FIGS. 12 and 13, when the wires 51 of the cable 5 is soldered to the connector 200, the wires 51 are sequentially and correspondingly distributed to the passages of the wire-separating block 6, that is, the wires 51 are inserted through the passages respectively, then the front end 511 of each wire 51 is disposed in each solder slot 21. The front end 511 of each wire 51 is soldered to the solder terminal portion 11 of the corresponding contact 1, as shown in FIG. 4, so that the adaptor is obtained, as shown in FIG. 13.

According to the embodiments of the present invention, the efficiency of manufacturing the terminal device 100, the connector 200, and the adaptor is increased, and quick soldering can be achieved. In addition, as described above, separating ribs 22 are formed between adjacent solder slots 21 for insulating the adjacent soldering units, so that shorts between the adjacent soldering units can be prevented from occurring and the high soldering reliability can be achieved.

Although embodiments have been shown and described, it will be appreciated by a person skilled in the art that changes can be made to the present invention without departing from its substantial spirit or essential principle. All the changes made within the scope of this invention or within the equivalent scope are included in this invention.

1-33. (canceled)

34. A terminal device, comprising:
an insulator including a solder slot formed in a surface thereof; and
a contact including a body portion, and a solder terminal portion formed at an end of the body portion and including a width that is larger than a thickness thereof; wherein the solder terminal portion is vertically disposed in the solder slot so that a width direction of the solder terminal portion is substantially identical with a depth direction of the solder slot.

35. The terminal device of claim 34, wherein the insulator comprises a first surface and a second surface opposite to the first surface, and the solder slot is formed in at least one of the first and second surfaces.

36. The terminal device of claim 34, wherein the insulator comprises a substantially rectangular parallelepiped shape.

37. The terminal device of claim 34, wherein a plurality of solder slots are formed side by side in at least one of a top surface and a bottom surface of the insulator and spaced apart from one another.

38. The terminal device of claim 34, wherein the contact includes a flat one-piece member, and wherein the body portion includes a twisted portion joined to the solder terminal portion so that the width direction of the solder terminal portion is substantially orthogonal to that of the body portion, optionally wherein the contact comprises a substantially Z-shape.

39. The terminal device of claim 38, wherein the longitudinal axis of the solder terminal portion is spaced apart from that of the body portion.

40. The terminal device of claim 34, wherein the solder terminal portion is twisted by about 90 degrees around a predetermined axis parallel with the longitudinal axis of the solder terminal portion, so that the width direction of the solder terminal portion is substantially orthogonal to that of the body portion.

41. The terminal device of claim 34, wherein the body portion further comprises:
a hold portion formed by a vertical portion located substantially at the center of the contact; a transition portion located between the twisted portion and an upper end of the hold portion; and a contact portion formed by a horizontal portion joined to a lower end of the hold portion, and
optionally wherein the contact portion comprises an elastic support part joined to the lower end of the hold portion; a lapping contact part formed at a free end of the contact portion away from the hold portion; and a projection contact part located between the elastic support part and the lapping contact part and protruding upward.

42. A method of manufacturing a terminal device, comprising:
preparing an insulator including a solder slot formed in a surface thereof;
preparing a contact including a body portion, and a solder terminal portion formed at an end of the body portion and including a width that is larger than a thickness thereof; and disposing the solder terminal portion vertically in the solder slot so that a width direction of the solder terminal portion is substantially identical with a depth direction of the solder slot.

43. The method of claim 42, wherein the solder terminal portion is disposed so as to abut against a side wall of the solder slot.

44. The method of claim 42, wherein the insulator comprises a first surface and a second surface opposite to the first surface, and the solder slot is formed in at least one of the first and second surfaces, and optionally wherein the plurality of solder slots are spaced apart at approximately equal intervals.

45. The method of claim 44, wherein a plurality of solder slots are formed side by side in at least one of a top surface and a bottom surface of the insulator and spaced apart from one another.

46. The method of claim 42, wherein the contact is formed by a flat one-piece member, and wherein a portion of the body portion joined to the solder terminal portion is twisted so as to form a twisted portion and the width direction of the solder terminal portion is substantially orthogonal to that of the body portion.

47. The method of claim 46, wherein the longitudinal axis of the solder terminal portion is spaced apart from that of the body portion.

48. The method of claim 47, wherein the solder terminal portion is twisted by about 90 degrees around a predetermined axis parallel with the longitudinal axis of the solder terminal portion, so that the width direction of the solder terminal portion is substantially orthogonal to that of the body portion.

49. A connector, comprising a terminal device according to claim 1.

50. The connector of claim 49, wherein the connector comprises a plug connector or a receptacle connector.

51. An adaptor, comprising:
a cable including a plurality of wires; and a connector according to claim 49, wherein the plurality of wires are soldered at their ends to sides of the solder terminal portions in the solder slots, respectively.

52. The adaptor of claim 51, further comprising a wire-separating block including a plurality of passages spaced apart from one another, wherein the plurality of wires are extended through the passages so as to be soldered to the solder terminal portions, respectively.

53. The adaptor of claim 52, wherein at least one of the passages comprises a cross-sectional area different from that of remaining passages.
